(19) United States
(12) Patent Application Publication
(10) Pub. No.: US 2009/0063881 A1
(43) Pub. Date: Mar. 5, 2009

(54) Low-overhead/power-saving processor synchronization mechanism, and applications thereof

(75) Inventor: Nigel John Stephens, London (GB)

Correspondence Address: STERNE, KESSLER, GOLDSTEIN & FOX P.L.L.C., 1100 NEW YORK AVENUE, N.W., WASHINGTON, DC, 20005, US

(73) Assignee: MIPS Technologies, Inc., Mountain View, CA (US)

(21) Appl. No.: 11/896,424

(22) Filed: Aug. 31, 2007

(51) Int. Cl. G06F 9/30; G06F 1/32

(52) U.S. Cl. 713/320; 712/226; 712/E09.032

(57) ABSTRACT

A low-overhead/power-saving processor synchronization mechanism, and applications thereof. In an embodiment, the present invention provides a processor having a load-linked register. The processor implements instructions related to the load-linked register. A first instruction, when executed by the processor, causes the processor to load a first value specified by the first instruction in a first register of a register file and to load a second value in the load-linked register. A second instruction, when executed by the processor, causes the processor to suspend execution of a stream of instructions associated with the load-linked register if the second value in the load-linked register is unaltered until the second value in the load-linked register is altered. A third instruction, when executed by the processor, causes the processor to conditionally move a third value to a memory location specified by the third instruction and to move a value representing the state of the load-linked register to the third register.

### FIELD OF THE PRESENT INVENTION

The present invention generally relates to processors. More particularly, it relates to processor synchronization mechanisms.

### BACKGROUND OF THE PRESENT INVENTION

In computer science, a test-and-set instruction is frequently used to implement synchronization primitives such as, for example, mutual exclusion locks and semaphores. A test-and-set instruction is an instruction that both tests and conditionally writes to a memory location as part of a single non-interruptible or atomic operation.

A short lived lock is typically implemented as a spin lock. A spin lock is an instruction loop containing, for example, a test-and-set instruction. The loop of instructions is repeatedly executed until the test-and-set instruction can successfully modify a word in memory which represents the state of a lock, for example by atomically changing a word in memory from value 0 representing unlocked to value 1 representing locked.

While conventional synchronization primitives such as spin locks are efficient when used in a symmetric multi-processing environment (e.g., because a processor has nothing else to do until the lock is acquired), this is not the case in a multi-threaded processor that multiplexes several threads through a single pipeline. In a multi-threaded processor, a spinning thread waiting for a lock wastes processing cycles that could be used by other threads and most likely increases the time until the required lock is released.

What are needed are new synchronization mechanisms that overcome the deficiencies noted above.

### BRIEF SUMMARY OF THE PRESENT INVENTION

The present invention provides a low-overhead/power-saving processor synchronization mechanism, and applications thereof. In an embodiment, the present invention includes a processor having at least one register file and at least one load-linked register. The processor implements instructions related to the load-linked register. A first instruction, when executed by the processor, causes the processor to load a first value from a memory location specified by the first instruction in a first register of a register file and to simultaneously load a second value in the load-linked register. A second instruction, when executed by the processor, causes the processor to suspend execution of a stream of instructions associated with the load-linked register until the second value in the load-linked register is altered. A third instruction, when executed by the processor, causes the processor to conditionally move a third value stored in a third register (which may be the same as the first register) to a memory location specified by the third instruction if the second value in the load-linked register has not been altered since execution of the first instruction, and to unconditionally copy the value stored in the load-linked register to the third register. The value in the load-linked register will be altered by a number of events including, for example, any write to memory in the proximity of the memory location specified by the first instruction by any processor in the system.

Further embodiments, features, and advantages of the present invention, as well as the structure and operation of various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the present invention and to enable a person skilled in the pertinent art to make and use the present invention.

FIG. 1A is a diagram of a processor according to an embodiment of the present invention.

FIG. 1B is a diagram that illustrates a portion of a multithreading processor according to an embodiment of the present invention.

FIG. 2 is a diagram of a first instruction implemented by a processor according to an embodiment of the present invention.

FIG. 3 is a diagram of a second instruction implemented by a processor according to an embodiment of the present invention.

FIG. 4 is a diagram of a third instruction implemented by a processor according to an embodiment of the present invention.

FIG. 5 is a flowchart of an example method according to an embodiment of the present invention.

FIG. 6 is a diagram of an example system according to an embodiment of the present invention.

The present invention is described with reference to the accompanying drawings. The drawing in which an element first appears is typically indicated by the leftmost digit or digits in the corresponding reference number.

### DETAILED DESCRIPTION OF THE PRESENT INVENTION

The present invention provides a low-overhead/power-saving processor synchronization mechanism, and applications thereof. In the detailed description of the present invention that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In an embodiment, the present invention provides a processor having at least one register file and at least one load-linked register. The processor implements instructions related to the load-linked register. A first instruction, when executed by the processor, causes the processor to load a first value specified by the first instruction in a first register of a register file and to load a second value in the load-linked register. A second instruction, when executed by the processor, causes the processor to suspend execution of a stream of instructions associated with the load-linked register until the second value in the load-linked register is altered. A third instruction, when executed by the processor, causes the processor to conditionally move a third value stored in a third register to a memory location specified by the third instruction if the second value in the load-linked register has not been altered since execution of the first instruction, and to unconditionally copy the value stored in the load-linked register to the third register.

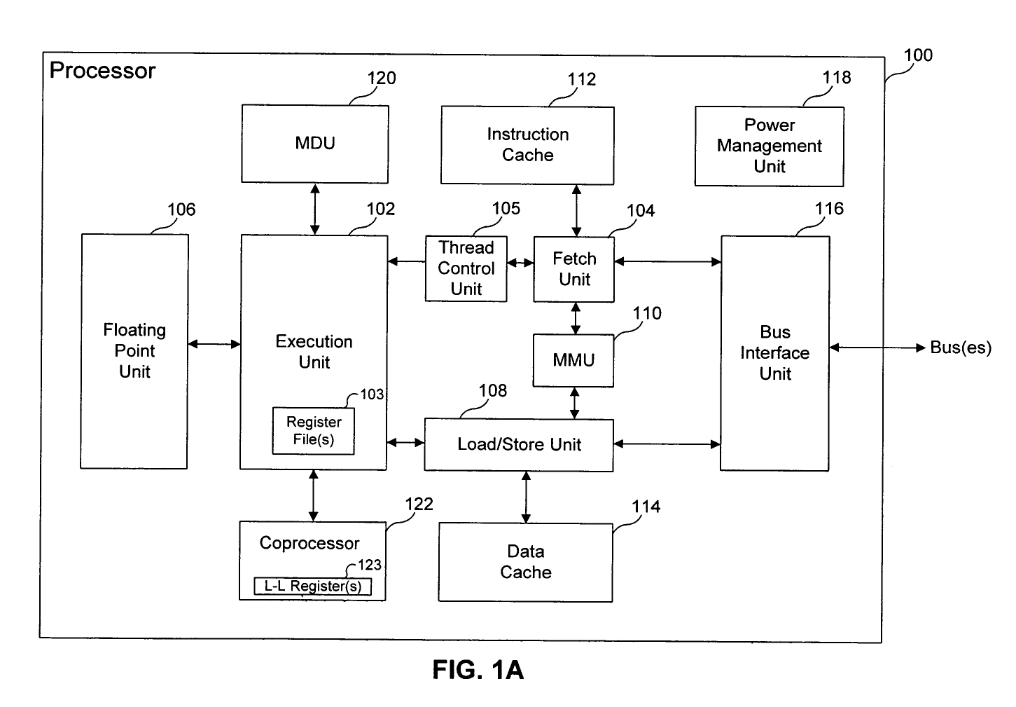

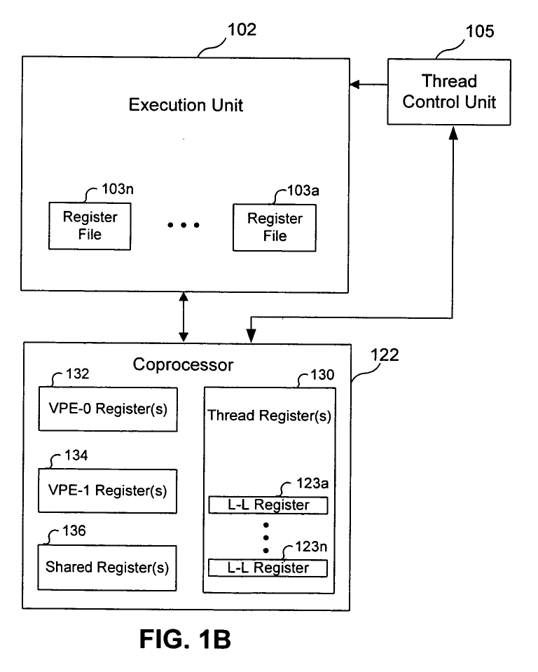

FIG. 1A is a diagram of an exemplary processor 100 capable of implementing an embodiment of the present invention. As shown in FIG. 1A, processor 100 includes an execution unit 102, a fetch unit 104, a thread control unit 105 (e.g., in the case of a multithreading processor), a floating point unit 106, a load/store unit 108, a memory management unit (MMU) 110, an instruction cache 112, a data cache 114, a bus interface unit 116, a power management unit 118, a multiply/divide unit (MDU) 120, and a coprocessor 122. While processor 100 is described herein as including several separate components, many of these components are optional components that will not be present in each embodiment of the present invention, or components that may be combined, for example, so that the functionality of two components reside within a single component. Thus, the individual components shown in FIG. 1A are illustrative and not intended to limit the present invention.

Execution unit 102 preferably implements a load-store, Reduced Instruction Set Computer (RISC) architecture with arithmetic logic unit operations (e.g., logical, shift, add, subtract, etc.). In one embodiment, execution unit 102 has at least one register file 103 that includes 32-bit general purpose registers (not shown) used for scalar integer operations and address calculations. One or more additional register files can be included, for example, in the case of a multithreading processor and/or to minimize context switching overhead, for example, during interrupt and/or exception processing. Execution unit 102 interfaces with fetch unit 104, floating point unit 106, load/store unit 108, multiple/divide unit 120 and coprocessor 122.

Fetch unit 104 is responsible for providing instructions to thread control unit 105 (e.g., in the case of a multithreading processor) and/or execution unit 102. In one embodiment, fetch unit 104 includes control logic for instruction cache 112, a recoder for recoding compressed format instructions, dynamic branch prediction logic, an instruction buffer, and an interface to a scratch pad (not shown). Fetch unit 104 interfaces with thread control unit 105 or execution unit 102, memory management unit 110, instruction cache 112, and bus interface unit 116.

Thread control unit 105 is present in a multithreading processor and is used to schedule instruction threads. In an embodiment, thread control unit 105 includes a policy manager that ensures processor resources are shared by executing threads. Thread control unit 105 interfaces with execution unit 102 and fetch unit 104.

Floating point unit 106 interfaces with execution unit 102 and operates on non-integer data. As many applications do not require the functionality of a floating point unit, this component of processor 100 need not be present in some embodiments of the present invention.

Load/store unit 108 is responsible for data loads and stores, and includes data cache control logic. Load/store unit 108 interfaces with data cache 114 and other memory such as, for example, a scratch pad and/or a fill buffer. Load/store unit 108 also interfaces with memory management unit 110 and bus interface unit 116.

Memory management unit 110 translates virtual addresses to physical addresses for memory access. In one embodiment, memory management unit 110 includes a translation lookaside buffer (TLB) and may include a separate instruction TLB and a separate data TLB. Memory management unit 110 interfaces with fetch unit 104 and load/store unit 108.

Instruction cache 112 is an on-chip memory array organized as a multi-way set associative cache such as, for example, a 2-way set associative cache or a 4-way set associative cache. Instruction cache 112 is preferably virtually indexed and physically tagged, thereby allowing virtual-to-physical address translations to occur in parallel with cache accesses. In one embodiment, the tags include a valid bit and optional parity bits in addition to physical address bits. Instruction cache 112 interfaces with fetch unit 104.

Data cache 114 is also an on-chip memory array. Data cache 114 is preferably virtually indexed and physically tagged. In one embodiment, the tags include a valid bit and optional parity bits in addition to physical address bits. In embodiments of the present invention, data cache 114 can be selectively enabled and disabled to reduce the total power consumed by processor 100. Data cache 114 interfaces with load/store unit 108.

Bus interface unit 116 controls external interface signals for processor 100. In one embodiment, bus interface unit 116 includes a collapsing write buffer used to merge write-through transactions and gather writes from uncached stores.

Power management unit 118 provides a number of power management features, including low-power design features, active power management features, and power-down modes of operation.

Multiply/divide unit 120 performs multiply and divide operations for processor 100. In one embodiment, multiply/divide unit 120 preferably includes a pipelined multiplier, result and accumulation registers, and multiply and divide state machines, as well as all the control logic required to perform, for example, multiply, multiply-add, and divide functions. As shown in FIG. 1A, multiply/divide unit 120 interfaces with execution unit 102.

Coprocessor 122 performs various overhead functions for processor 100. In one embodiment, coprocessor 122 is responsible for virtual-to-physical address translations, implementing cache protocols, exception handling, operating mode selection, and enabling/disabling interrupt functions. In an embodiment, coprocessor 122 includes at least one load-linked (L-L) register 123. Load-linked register 123 can be either a single bit register or a multi-bit register. In one embodiment, load-linked register 123 is a flip-flop. In one embodiment, load-linked register 123 is a two-bit register. In an embodiment, there is a load-linked register and/or a load-linked bit for each program thread (e.g., in the case of a multithreading processor). In embodiments of the present invention, load-linked register 123 need not be implemented as part of coprocessor 122. For example, one or more load-linked registers 123 can be implemented as a part of thread control unit 105. In embodiments, the load-linked register(s) can be implemented as part of the load/store unit or the data cache. Coprocessor 122 interfaces with execution unit 102.

FIG. 1B is a diagram that illustrates a portion of a multithreading processor according to an embodiment of the present invention. As shown in FIG. 1B, in one embodiment, a multithreading processor according to the present invention has multiple register files 103a-n and a coprocessor 122 that includes per-thread (or thread context (TC)) register(s), per-virtual processing element (VPE) register(s), and per-processor register(s).

In an embodiment, each thread that can be executed concurrently by the processor has its own associated register file 103. In addition, each thread has its own associated thread register(s) 130, which are a part of coprocessor 122. In an embodiment, these per-thread register include load-linked (L-L) registers 123a-n. In an embodiment, each thread also has its own associated program counter register (not shown), which is used to hold the memory address for the next instruction of the thread to be executed. In an embodiment, each thread also has its own multiply/divide unit result and accumulator registers.

In addition to per-thread registers, in an embodiment, coprocessor 122 includes registers that are shared by one or more threads. These shared registers together with the per-thread registers of the one or more threads, and other resources as necessary, form a virtual processing element (VPE). A multithreading processor according to the present invention may have one or more virtual processing elements. Each virtual processing element of a processor appears to software to be a separate processor (e.g., a multithreading processor having two virtual processing elements appears to software to be almost the same as two separate processors sharing memory in a symmetric multiprocessing system). In FIG. 1B, register(s) 132 are associated with a first virtual processing element (VPE-0). Register(s) 134 are associated with a second virtual processing element (VPE-1).

In an embodiment, coprocessor 122 also includes shared register(s) 136. In an embodiment, shared register(s) 136 are registers that provide, for example, an inventory of the processor's resources (e.g., how many threads can be executed concurrently, how many virtual processing elements are implemented, etc.).

As shown in FIG. 1B, information stored in the registers of coprocessor 122 can be communicated to execution unit 102 and/or thread control unit 105. In this manner, a policy manager of thread control unit 105 knows, for example, the value stored in each load-linked register 123 of coprocessor 122. As described herein, the value stored in a load-linked register can be used to suspend execution of a thread associated with the load-linked register. In an embodiment, the associated thread is suspended by using the value stored in the associated load-linked register to enable and/or disable the fetching and/or execution of instructions belonging to the associated thread. When a value in a load-linked register changes, this value is immediately communicated, for example, to thread control unit 105. Thread control unit 105 can use this change to resume execution of a particular thread.

In one embodiment, load-linked registers 123 are per-virtual processing element registers rather than per-thread registers.

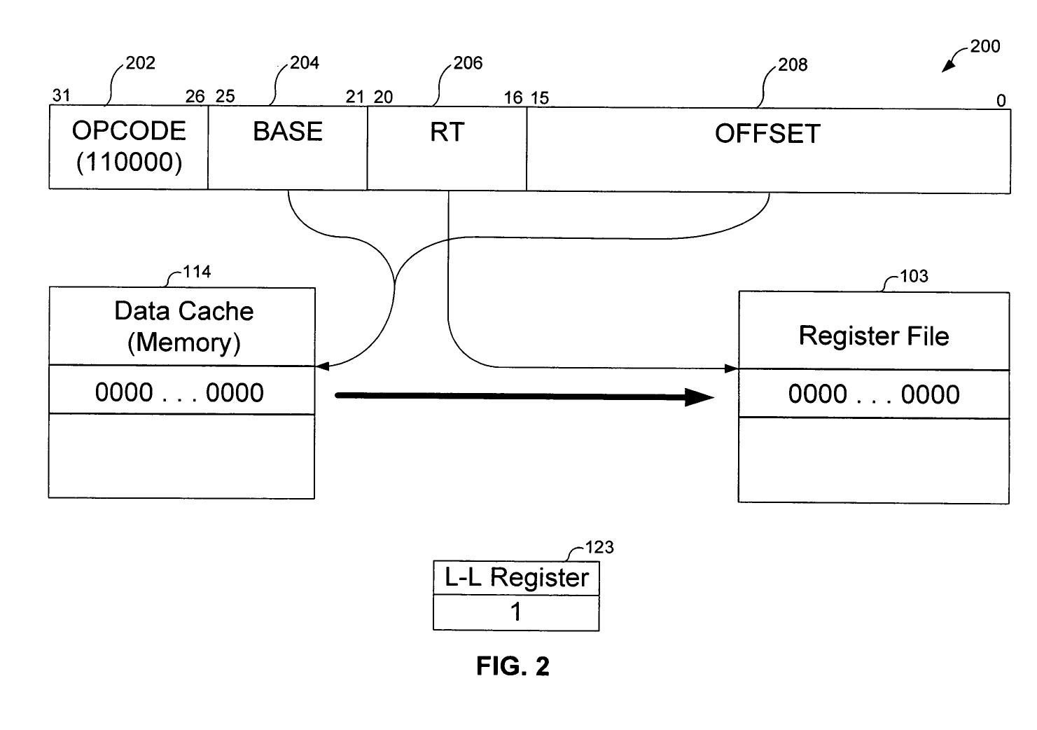

FIG. 2 is a diagram of an instruction 200 implemented by a processor according to an embodiment of the present invention. As shown in FIG. 2, instruction 200 includes an opcode 202, a base address register identifier 204, a destination register identifier 206, and an address offset value 208. In an embodiment, instruction 200 includes 32 bits that are allocated as shown in FIG. 2.

When executed by a processor such as, for example, processor 100, instruction 200 causes the processor to move the contents of a word stored at a memory location specified by base address register identifier 204 and address offset value 208 of instruction 200 to a register of a register file 103 specified by destination register identifier 206 of instruction 200. In an embodiment, the address of the memory location is formed by sign-extending address offset value 208 and adding it to the contents of the register specified by base address register identifier 204. In an embodiment, executing instruction 200 also causes a value of one to be stored in a load-linked register according to the present invention. In the MIPS instruction set architecture, instruction 200 is referred to as a load-linked (LL) instruction.

As illustrated by FIG. 2, in an embodiment, executing instruction 200 using processor 100 causes an n-bit value (where n is a power of two) stored in data cache 114 to be loaded into a register of register file 103. In addition, a value of 1 is loaded into load-linked register 123.

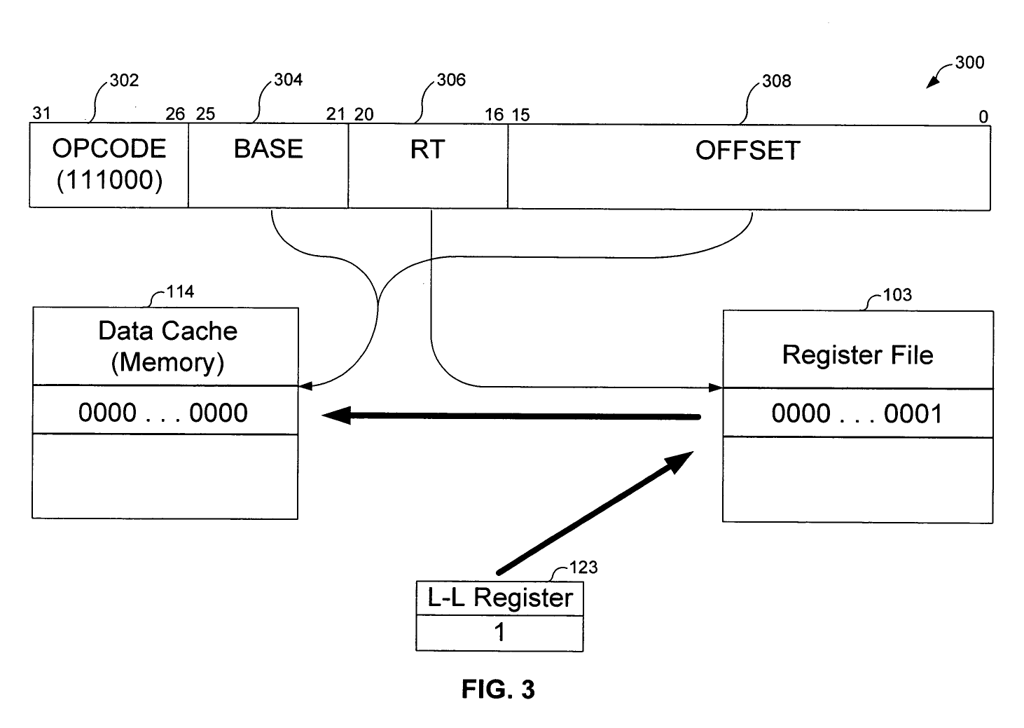

FIG. 3 is a diagram of an instruction 300 implemented by a processor according to an embodiment of the present invention. As shown in FIG. 3, instruction 300 includes an opcode 302, a base address register identifier 304, a source register identifier 306, and an address offset value 308. In an embodiment, instruction 300 includes 32 bits that are allocated as shown in FIG. 3.

When executed by a processor such as, for example, processor 100, instruction 300 causes the processor to conditionally move the contents of a register of a register file 103 specified by source register identifier 306 of instruction 300 to a memory location specified by base address register identifier 304 and address offset value 308 of instruction 300 if the value 1 is in the load-linked register. In an embodiment, the address of the memory location is formed by sign-extending address offset value 308 and adding it to the contents of the register specified by base address register identifier 304. In addition, executing instruction 300 causes a value stored in a load-linked register to be unconditionally zero-extended and stored in the register of the register file specified by source register identifier 306 of instruction 300. In the MIPS instruction set architecture, instruction 300 is referred to as a store conditional (SC) instruction.

As illustrated by FIG. 3, in an embodiment, executing instruction 300 using processor 100 causes an n-bit value (where n is a power of two) stored in a register of register file 103 to be stored in data cache 114. In addition, a value (e.g., one) stored in load-linked register 123 is zero-extended and stored in the register of register file 103 specified by instruction 300.

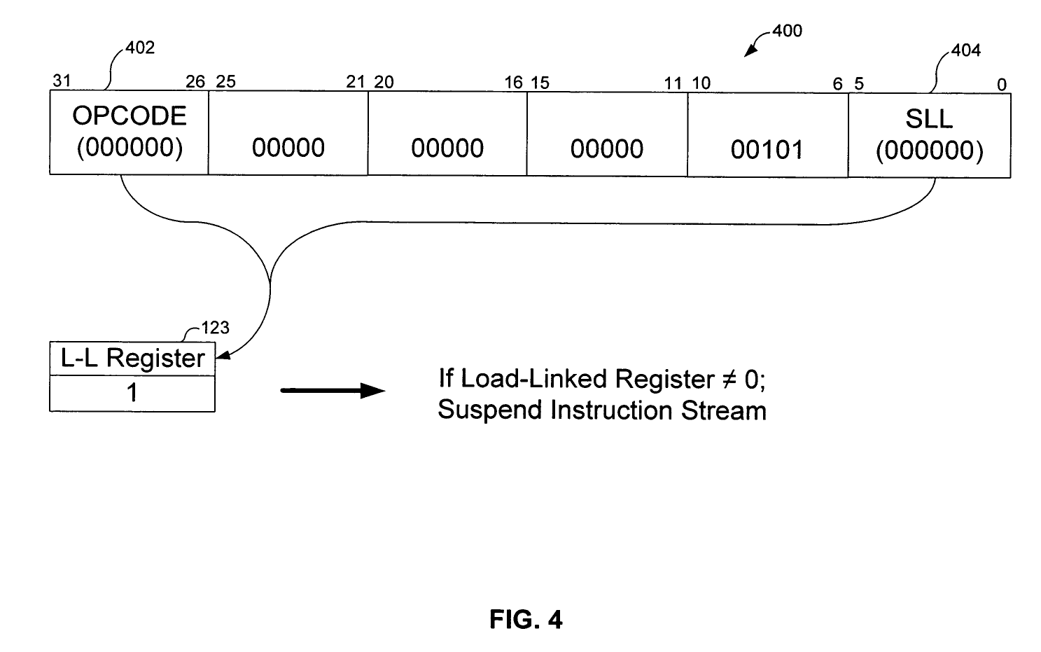

FIG. 4 is a diagram of an instruction 400 implemented by a processor according to an embodiment of the present invention. As shown in FIG. 4, instruction 400 includes an opcode 402 and an opcode extension 404. Opcode 402 and opcode extension 404 identify instruction 400 as a pipeline yield based on load-linked value instruction (YIELDLL). In an embodiment, instruction 400 does not require any operands. In an embodiment, instruction 400 includes 32 bits allocated as shown in FIG. 4.

When executed by a processor such as, for example, processor 100, instruction 400 causes the processor to suspend a stream of instructions associated with a load-linked register if a non-zero value is stored in the load-linked register. In an embodiment, instruction 400 is also used to power-down at least a portion of the processor, for example, if a non-zero value is stored in the load-linked register. Any suspended instruction stream remains suspended, and any powered-down portion of the processor remains powered-down, until the value stored in the load-linked register is altered or cleared (e.g., the value becomes zero). After the value in the load-linked register is altered or cleared, any suspended stream of instructions is restarted at the next instruction following instruction 400 in the stream of instructions. In the MIPS instruction set architecture, as of August 2007, no instruction equivalent to instruction 400 exists, and there is no instruction that performs the functionality of instruction 400. In an embodiment, instruction 400 is encoded in such a way that existing MIPS legacy processors respond to the instruction as a no-operation (nop) instruction, thereby allowing instruction 400 to be safely included in library code and operating systems capable of running on any MIPS processor or on any MIPS instruction set architecture compatible processor.

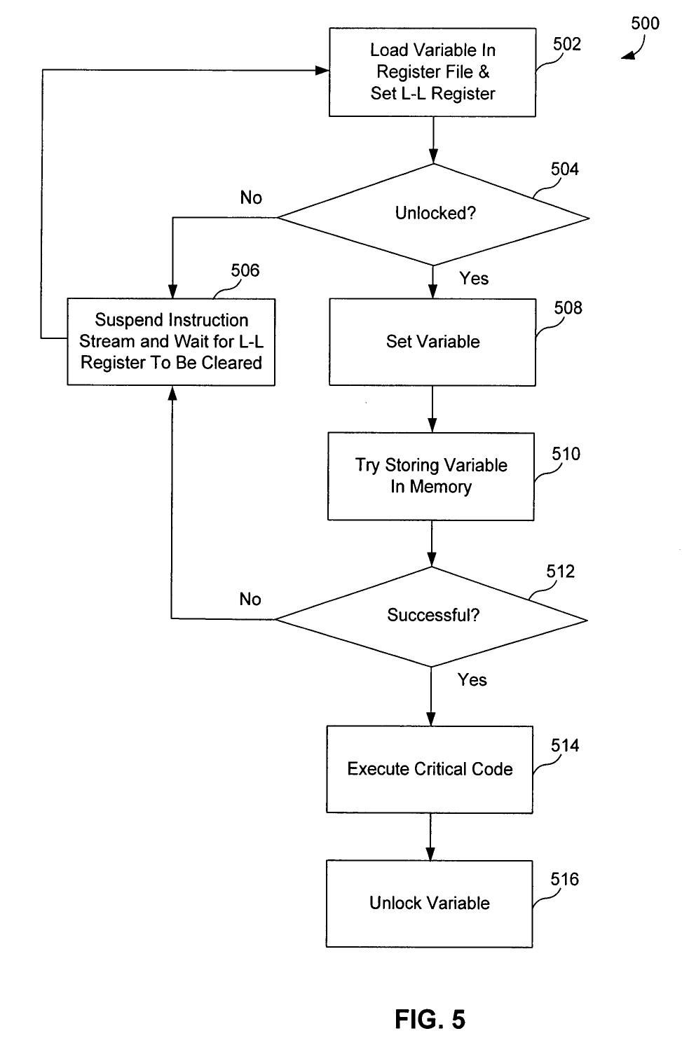

In embodiments, instructions 200, 300, and 400 are used to implement, for example, mutual exclusion locks. How to implement a lock using these instructions will now be described with reference to FIG. 5 and Table 1 below.

FIG. 5 is a flowchart of an example method 500 for implementing a lock according to an embodiment of the present invention. Method 500 begins at step 502.

In step 502, a variable in memory used to represent the state of a lock is loaded into a register of a processor register file. At the time the variable is loaded into the register, a value (e.g., one) is stored in a load-linked register. In an embodiment, the load-linked register is a flip-flop that is set. Step 502 can be performed using instruction 200. Control passes from step 502 to step 504.

In step 504, the value loaded into the register of the register file is checked to determine the state of the lock (e.g., whether the lock is locked or unlocked). This check can be performed using a conditional branch instruction. If it is determined in step 504 that the lock is unlocked, control passes to step 508. Otherwise, control passes to step 506.

In step 506, execution of a stream of instructions is suspended if the value stored in the load-linked register is still one (or if the load-linked flip-flop is still set) until the value stored in the load-linked register (or the state of the load-linked flip-flop) is altered or cleared. Step 506 can be implemented using instruction 400. In an embodiment, instruction 400 is specified by a programmer using the programming notation “yieldll” or “sll $0, $0, 5”. Other notations can be used in other embodiments. In an embodiment, instruction 400 also causes at least a part of the processor executing instruction 400 to be powered-down until the value stored in the load-linked register (or the state of the load-linked flip-flop) is altered or cleared. Once the value stored in the load-linked register (or load-linked flip-flop) is altered or cleared, control passes back to step 502.

In step 508, the variable used to indicate the state of the lock (e.g., the value stored in the register file) is set/changed to indicate a locked state for the lock. This can be performed, for example, by adding a value (e.g., 1) to the register loaded in step 504 which is used to indicate the state of the lock. Control passes from step 508 to step 510.

In step 510, an attempt is made to write the register modified in step 508 to memory. In an embodiment, if the variable is successfully written to memory, the register that previously held the variable will store a value of one (e.g., a zero-extended version of the value stored in the load-linked register). If the variable cannot be written to memory (e.g., because the value stored in the load-linked register is zero), the register that previously held the variable will store a value of zero. Step 510 can be implemented, for example, using instruction 300.

In step 512, a check is made to determine whether the attempt to store the variable in step 510 was successfully. This can be performed using a conditional branch instruction. If the variable was successfully written to memory, control passes to step 514. Otherwise, control passes to step 506 or to step 502.

In step 514, critical code (e.g., critical region code) is executed. In an embodiment, the critical code is code requiring exclusive access to a shared resource, for example, while it is executing. After completion of the critical code, control passes from step 514 to step 516.

In step 516, the lock is released. This step can be implemented using a store word instruction to store the value zero to the variable representing the state of the lock. In releasing the lock, the value in the load-linked register (load-linked flip-flop) is altered or reset. Resetting this value enables any suspended instruction streams to attempt to acquire the lock again. In an embodiment, resetting the load-linked register (load-linked flip-flop) also powers-up any portion of the processor that was powered-down in step 506

Table 1 below illustrates example code for implementing method 500. The codes is presented using instructions of the MIPS instruction set architecture and the novel instruction 400 described herein. As noted above, the MIPS instruction set architecture does not include an instruction equivalent to instruction 400, and there is no instruction that performs the functionality of instruction 400 in the MIPS instruction set architecture.

It is noted here that the present invention is not limited to implementing the lock presented in Table 1 or the code presented in Table 1. Given the description of the present invention herein, persons skilled in the relevant art(s) will understand how to use the present invention to implement other forms of lock and synchronization mechanisms using other program code. Accordingly, the claimed invention is not to be limited in any way by the example lock and the example code of Table 1.

TABLE 1
Example Code For A Non-Spinning Lock

| | | | |
|---|---|---|---|
| acquire_lock: | ll | t0, 0(a0) | /*read lock; set L-L |
| | | Register*/ | |
| | bnez | t0, acquire_lock_retry | /*branch if lock taken*/ |
| | addiu | t0, t0, 1 | /*set lock*/ |
| | sc | t0, 0(a0) | /*try to store lock*/ |
| | bnez | t0, start_critical_code | /*branch if lock acquired*/ |
| | sync | | /*synchronize loads and |
| | | | stores - in branch delay slot |
| | | */ | |

| | | |
|---|---|---|
| acquire_lock_retry: | yieldll | /*suspend instruction stream |
| | | until L-L Register value is clear*/ |
| | b acquire_lock | /*branch to acquire lock*/ |
| | nop | /*optional nop if processor |
| | | has branch delay slot*/ |
| start_critical_code: | start critical code | /*execute critical code*/ |
| | * * * | /*execute critical code*/ |
| | end critical code | /*execute critical code*/ |
| release_lock: | sync | /*synchronize loads and |
| | | stores*/ |
| | sw zero, 0(a0) | /*release software lock; |
| | | clear L-L Register*/ |

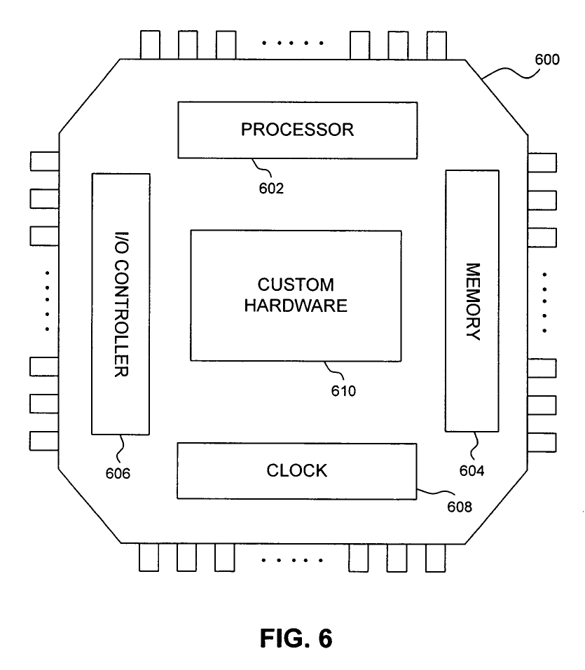

FIG. 6 is a diagram of an example system 600 according to an embodiment of the present invention. System 600 includes a processor 602, a memory 604, an input/output (I/O) controller 606, a clock 608, and custom hardware 610. In an embodiment, system 600 is a system on a chip (SOC) in an application specific integrated circuit (ASIC).

Processor 602 is any processor that includes features of the present invention described herein and/or implements a method embodiment of the present invention. In one embodiment, processor 602 includes an instruction fetch unit, an instruction cache, an instruction decode and dispatch unit, one or more instruction execution unit(s), a data cache, a register file, and a bus interface unit similar to processor 100 described above.

Memory 604 can be any memory capable of storing instructions and/or data. Memory 604 can include, for example, random access memory and/or read-only memory.

Input/output (I/O) controller 606 is used to enable components of system 600 to receive and/or send information to peripheral devices. I/O controller 606 can include, for example, an analog-to-digital converter and/or a digital-to-analog converter.

Clock 608 is used to determine when sequential subsystems of system 600 change state. For example, each time a clock signal of clock 608 ticks, state registers of system 600 capture signals generated by combinatorial logic. In an embodiment, the clock signal of clock 608 can be varied. The clock signal can also be divided, for example, before it is provided to selected components of system 600.

Custom hardware 610 is any hardware added to system 600 to tailor system 600 to a specific application. Custom hardware 610 can include, for example, hardware needed to decode audio and/or video signals, accelerate graphics operations, and/or implement a smart sensor. Persons skilled in the relevant arts will understand how to implement custom hardware 610 to tailor system 600 to a specific application.

While various embodiments of the present invention have been described above, it should be understood that they have been presented by way of example, and not limitation. It will be apparent to persons skilled in the relevant computer arts that various changes in form and detail can be made therein without departing from the scope of the invention. For example, in addition to using hardware (e.g., within or coupled to a Central Processing Unit (“CPU”), microprocessor, microcontroller, digital signal processor, processor core, System on Chip (“SOC”), or any other device), implementations may also be embodied in software (e.g., computer readable code, program code and/or instructions disposed in any form, such as source, object or machine language) disposed, for example, in a computer usable (e.g., readable) medium configured to store the software. Such software can enable, for example, the function, fabrication, modeling, simulation, description and/or testing of the apparatus and methods described herein. For example, this can be accomplished through the use of general programming languages (e.g., C, C++), hardware description languages (HDL) including Verilog HDL, VHDL, SystemC Register Transfer Level (RTL), and so on, or other available programs. Such software can be disposed in any known computer usable medium such as semiconductor, magnetic disk, optical disk (e.g., CD-ROM, DVD-ROM, etc.). The software can also be disposed as a computer data signal embodied in a computer usable (e.g., readable) transmission medium (e.g., carrier wave or any other medium including digital, optical, or analog-based medium). Embodiments of the present invention may include methods of providing an apparatus described herein by providing software describing the apparatus and subsequently transmitting the software as a computer data signal over a communication network including the Internet and intranets.

It is understood that the apparatus and method embodiments described herein may be included in a semiconductor intellectual property core, such as a microprocessor core (e.g., embodied in HDL) and transformed to hardware in the production of integrated circuits. Additionally, the apparatus and method embodiments described herein may be embodied as a combination of hardware and software. Thus, the present invention should not be limited by any of the above-described exemplary embodiments, but should be defined only in accordance with the following claims and their equivalence. Furthermore, it should be appreciated that the detailed description of the present invention provided herein, and not the summary and abstract sections, is intended to be used to interpret the claims. The summary and abstract sections may set forth one or more but not all exemplary embodiments of the present invention.

What is claimed is:

1. A processor, comprising:
a load-linked register,
wherein execution of a first instruction by the processor causes the processor to suspend execution of a stream of instructions associated with the load-linked register if a first value is stored in the load-linked register.

2. The processor of claim 1, further comprising:
a register file that includes a plurality of registers,
wherein execution of a second instruction by the processor causes the processor to load a memory value specified by the second instruction in a first register of the register file and to load a value in the load-linked register.

3. The processor of claim 2, wherein execution of a third instruction by the processor causes the processor to conditionally move a value to a memory location specified by the third instruction if the value in the load-linked register has not been altered since execution of the second instruction, and to load a value representing the state of the load-linked register to a register of the register file.

4. The processor of claim 3, wherein the value loaded from the load-linked register to the register of the register file is zero-extended.

5. The processor of claim 1, wherein the load-linked register is a one-bit or a two-bit register.

6. The processor of claim 1, further comprising:
a second load-linked register.

7. A system, comprising:
a processor that includes
a register file that includes a plurality of registers, and
a load-linked register,
wherein execution of a first instruction by the processor causes the processor to load a first value specified by the first instruction in a first register of the register file and to load a second value in the load-linked register, and
wherein execution of a second instruction by the processor causes the processor to suspend execution of a stream of instructions associated with the load-linked register until the value in the load-linked register is different from the second value; and
a memory coupled to the processor.

8. The system of claim 7, wherein the load-linked register is a one-bit or a two-bit register.

9. The system of claim 7, wherein execution of the first instruction loads a value of one in the load-linked register.

10. The system of claim 7, wherein execution of a third instruction by the execution unit causes the processor to load a value representing the value stored in the load-linked register to a register of the register file.

11. The system of claim 7, wherein the processor further includes a second register file that includes a plurality of registers and a second load-linked register.

12. A control method for a computing system, comprising:
(1) executing a first instruction that loads a first value specified by the first instruction in a first register of a register file and that loads a second value in a load-linked register;
(2) executing a second instruction that suspends execution of a stream of instructions associated with the load-linked register until the value in the load-linked register is different from the second value; and
(3) executing a third instruction that conditionally moves a third value to a memory location specified by the third instruction if the value in the load-linked register has not been altered since execution of the first instruction, and that loads a representation of the value stored in the load-linked register to a register of the register file.

13. The method of claim 12, wherein (1) comprises:
loading a value of one in the load-linked register.

14. The method of claim 12, further comprising:
(4) powering-down at least a portion of a processor as a result of executing the second instruction.

15. A control method for a computing system, comprising:
(1) executing a first instruction that loads a first value specified by the first instruction in a first register of a register file and that loads a second value in a load-linked register;
(2) executing a second instruction that suspends execution of a stream of instructions associated with the load-linked register until the second value in the load-linked register is altered; and
(3) powering-down a portion of a processor as a result of executing the second instruction.

16. The method of claim 15, wherein (1) comprises:
loading a value of one in the load-linked register.

17. The method of claim 15, further comprising:
(4) powering-up the portion of the processor when the second value in the load-linked register is altered.

18. A computer method for implementing a lock, comprising:
(1) executing a sequence of instructions that cause a multithreading processor to suspend execution of a selected thread of instructions in response to a value stored in a hardware controlled load-linked register; and
(2) resuming execution of the suspended stream of instructions in response to a change in the value stored in the load-linked register.

19. The method of claim 18, wherein (1) comprises executing a YIELDLL instruction.

20. The method of claim 18, wherein (1) comprises executing an instruction that is capable of running on any MIPS instruction set architecture compatible processor.
